(19) United States
(12) Patent Application Publication
(10) Pub. No.: US 2018/0366928 A1
(43) Pub. Date: Dec. 20, 2018

(54) ELECTRICAL WIRING DEVICE SUPPORT

(71) Applicant: Hubbell Incorporated, Shelton, CT (US)

(72) Inventors: Emircan Matthew Dumani, Shelton, CT (US); Sorin Ioan Mortun, Irvington, NY (US); Brian Edward Rock, Madison, CT (US)

(21) Appl. No.: 16/009,380

(22) Filed: Jun. 15, 2018

Related U.S. Application Data
(60) Provisional application No. 62/522,280, filed on Jun. 20, 2017.

(51) Int. Cl. H02G 3/08; H02G 3/14; H01R 25/00

(52) U.S. Cl. CPC H02G 3/081; H01R 25/003; H02G 3/14

(57) ABSTRACT

Electrical enclosures are provided. The electrical enclosure includes a base and a cover that can be releasably secured to each other. Either the base or the cover has a pair of end walls, a pair of side walls and a top or bottom surface forming an open interior portion. An electrical wiring device is positioned within the open interior portion of the cover or base and is secured to the cover. The electrical wiring device is accessible through at least one opening in the cover. A support member is positioned between each electrical wiring device and the base or cover.

### CROSS-REFERENCE TO RELATED APPLICATIONS

The present disclosure is based on and claims benefit from co-pending U.S. Provisional Application Ser. No. 62/522,280 filed Jun. 20, 2017 entitled “Electrical Wiring Device Support” the entire contents of which are incorporated herein by reference.

### BACKGROUND

### Field

The present disclosure relates generally to electrical enclosures, and more particularly to supports for electrical wiring devices for use in such electrical enclosures.

### Description of the Related Art

Electrical distribution systems deliver power throughout a building from a power source to electrical wiring devices. Electrical wiring devices are connected to the electrical distribution system by way of wiring terminals, and deliver power from the power source to a load, or control the power to a load. One or more electrical wiring devices can be mounted to are electrical box depending on the size of the electrical box, or to electrical enclosures depending on the size of the electrical enclosure. Electrical enclosures may include surface mounted raceway systems, surge protector power strips, relocatable power taps, multi-outlet assemblies, etc. Electrical enclosures typically include a base and a cover that is releasably secured to the base. In some electrical enclosures, when installing one or more electrical wiring devices, the cover of the enclosure is often used as the mount for the one or more electrical wiring devices. In some instances, a single screw may be used to secure each of the one or more electrical wiring devices to the cover, and then the cover is secured to the base. When using a single screw to secure the electrical wiring devices to the cover, repeated pushing, pulling or toggling of the electrical wiring devices may result in the electrical wiring device loosening and becoming unstable.

### SUMMARY

The present disclosure provides embodiments of electrical enclosures, and more particularly to supports for electrical wiring devices includes in such electrical enclosures. The electrical enclosures generally include a base and a cover that can be releasably secured to each other. Either the base or the cover has a pair of end walls, a pair of side walls and a top or bottom surface forming an open interior portion. An electrical wiring device is positioned within the open interior portion of the cover or base and is secured to the cover. The electrical wiring device is accessible through at least one opening in the cover. A support member is positioned between each electrical wiring device and the base or cover.

In one exemplary embodiment, the electrical enclosure includes a base, a cover, at least one electrical wiring device and at least one support member. The cover is releasably secured to the base and has a pair of end walls, a pair of side walls and a top surface forming an open interior portion. The at least one electrical wiring device is positioned within the open interior portion of the cover and is secured to the cover. The at least one electrical wiring device is accessible through at least one opening in the top surface of the cover. Each of the at least one support member is positioned between each of the at least one electrical wiring device and the base. Each at least one support member is preferably configured to contact the at least one electrical wiring device and the base when positioned between the at least one electrical wiring device and the base. As a result, forces exerted on the electrical wiring device can be absorbed by the support member. In one exemplary embodiment, each support member includes a body having two side walls, two end walls and a top wall. In another exemplary embodiment, each support member includes a base and a vertical wall connected to the base. The vertical wall may be integrally formed into the base, or the vertical wall can be secure to the base.

In another exemplary embodiment, the electrical enclosure also includes a base, a cover, at least one electrical wiring device and at least one support member. The base has a pair of end walls, a pair of side walls and a bottom surface forming an open interior portion. The cover can be releasably secured to the base. The at least one electrical wiring device is positioned within the open interior portion of the base and secured to the cover. The at least one electrical wiring device is accessible through at least one opening in the cover. The at least one support member is positioned between each electrical wiring device and the bottom surface of the base.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a side elevation view in partial cross-section of an exemplary embodiment of an electrical enclosure according to the present disclosure;

FIG. 2 is a bottom perspective view with parts separated of the electrical enclosure of FIG. 1, illustrating a base and a cover, a plurality of electrical wiring devices secured to the cover and a plurality of electrical wiring device supports positioned between the base and the plurality of electrical wiring devices;

FIG. 3 is a side elevation view with parts separated of the electrical enclosure of FIG. 1;

FIG. 4 is an end elevation view in partial cross-section of the electrical enclosure of FIG. 1;

FIG. 5 is a perspective view of an exemplary embodiment of a support member according to the present disclosure used to support an electrical wiring device;

FIG. 6 is a side elevation view of the support member of FIG. 5;

FIG. 7 is a side elevation view of an opposite side of the support member of FIG. 6;

FIG. 8 is a top plan view of the support member of FIG. 5;

FIG. 9 is a front elevation view of the support member of FIG. 5;

FIG. 10 is a perspective view of an exemplary embodiment of a mounting yoke of an electrical wiring device;

FIG. 11 is a side elevation view of the mounting yoke of FIG. 10 being supported by the support member of FIG. 6;

FIG. 12 is a side elevation view in partial cross-section of another exemplary embodiment of an electrical enclosure according to the present disclosure;

FIG. 13 is a top perspective view with parts separated of the electrical enclosure of FIG. 12, illustrating a base and a cover, a plurality of electrical wiring devices secured to the cover and a plurality of support members secured to the base and positioned between the base and the plurality of electrical wiring devices;

FIG. 14 is a top perspective view of the base of the electrical enclosure of FIG. 14 with a plurality of electrical wiring device supports secured to the base;

FIG. 15 is an enlarge view of a portion of the base and one of the of plurality of support members secured to the base taken from detail 15 in FIG. 14;

FIG. 16 is a side elevation view of a portion of the enclosure of FIG. 12 taken from detail 16 and illustrating another exemplary embodiment of the support member of the present disclosure;

FIG. 17 is an end elevation view in partial cross-section of the electrical enclosure of FIG. 12;

FIG. 18 is a perspective view of another exemplary embodiment of a support member according to the present disclosure;

FIG. 19 is a side elevation view of the electrical wiring device support of FIG. 18;

FIG. 20 is a front elevation view of the electrical wiring device support of FIG. 18; and

FIG. 21 is a bottom plan view of the electrical wiring device support of FIG. 18.

### DETAILED DESCRIPTION

The present disclosure relates generally to electrical enclosures, and more particularly to electrical enclosures with one or more electrical wiring devices mounted to the electrical enclosure and one or more support members positioned within the electrical enclosure and between the one or more electrical wiring devices. For ease of description, the electrical enclosures described herein may also be referenced as the “enclosure” in the singular and “enclosures” in the plural, and the electrical wiring devices described herein may also be referenced as the “device” in the singular and “devices” in the plural. Non-limiting examples of enclosures contemplated by the present disclosure include surface mounted raceway systems, power strip enclosures, surge protector power strip enclosures, relocatable power taps, multi-outlet assemblies, etc. Non-limiting examples of devices contemplated by the present disclosure include single receptacles, duplex receptacles, circuit interrupting receptacles, such as GFCI and AFCI receptacles, switch/receptacle combinations, toggle switches, three-way switches, USB chargers, rocker switches, press switches, occupancy sensors, lighted indicators, resettable overcurrent devices, motor controllers, etc.

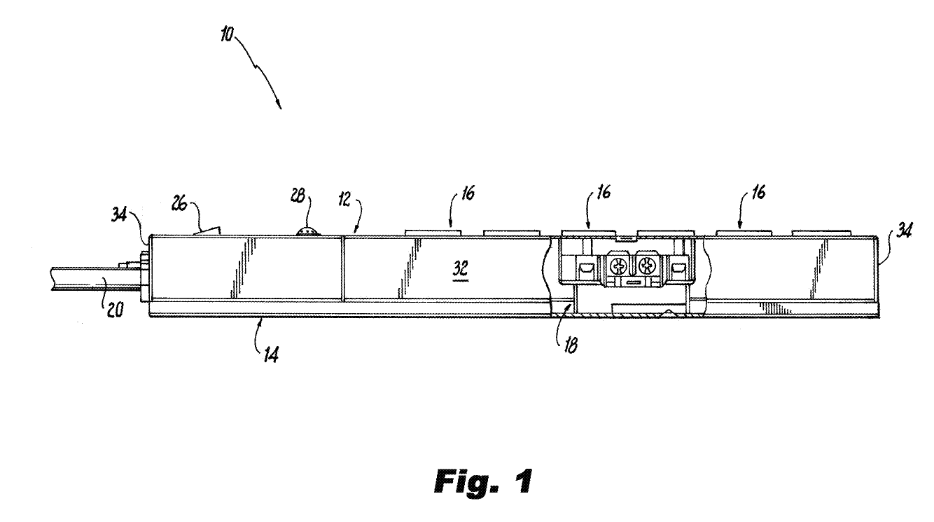

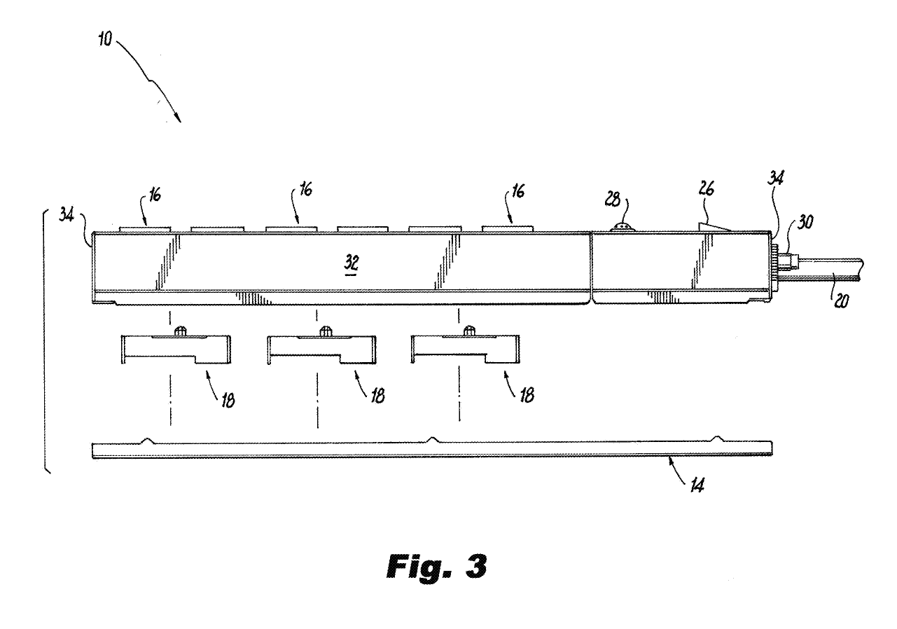

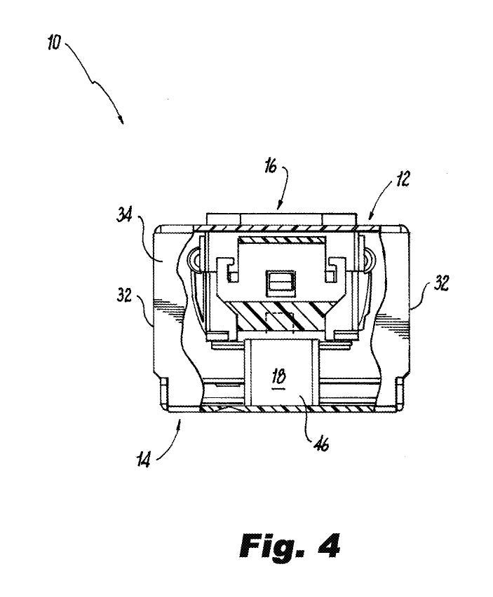

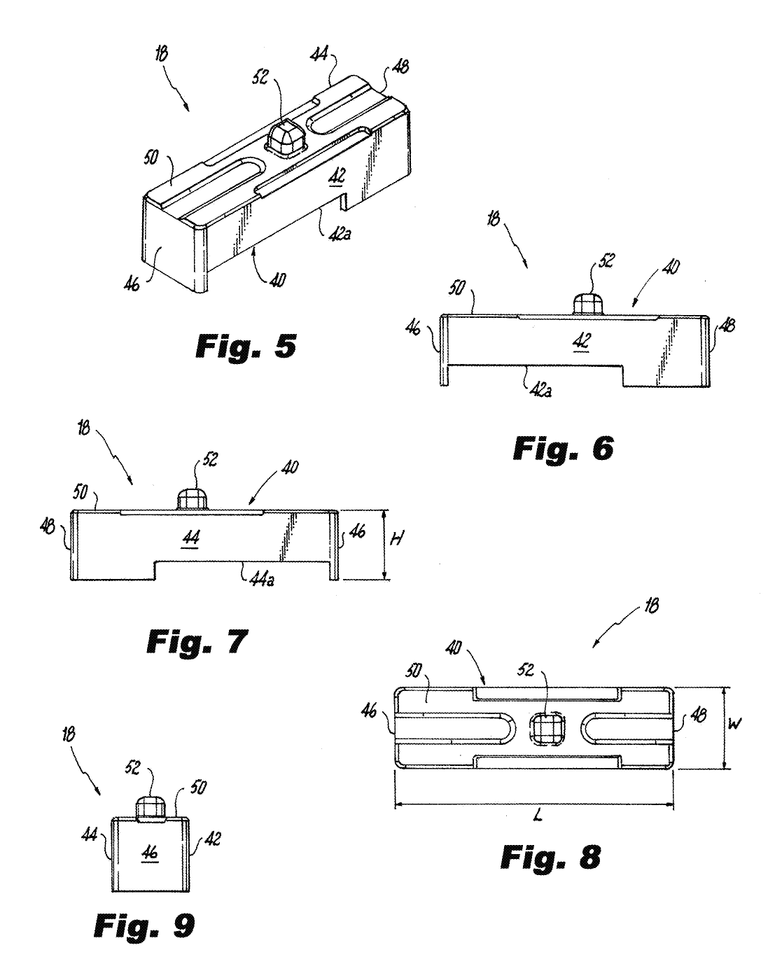

Turning to the figures and in particular FIGS. 1-4, the enclosure 10 includes a cover 12, a base 14, one or more devices 16 and one or more support members 18. The cover 12 in this exemplary embodiment is a rectangular shaped member having two side walls 32, two end walls 34 and a hollow interior. However, one skilled in the art would readily appreciate that the enclosure 10 can come in many shapes and sizes, including square and round shapes. The base 14 in this exemplary embodiment is a substantially flat member and is configured to be removably coupled to the cover 12 using, for example, mechanical fasteners such as threaded screws, or a snap-fit structure or a press-fit structure as is known. While the cover 12 is described herein as having two side walls 32, two end walls 34 and a hollow interior, and the base 14 is described as a substantially flat member that is configured to be removably coupled to the cover 12, the present disclosure contemplates that the base 14 may having two side walls 32, two end walls 34 and a hollow interior, and the cover 12 may be a substantially flat member that is configured to be removably coupled to the base.

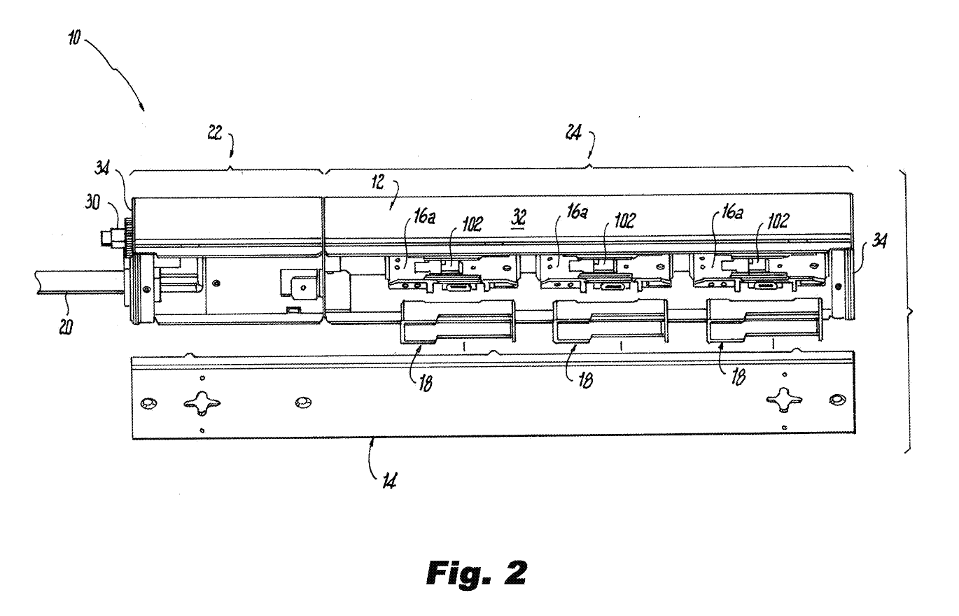

In the exemplary embodiment shown in FIGS. 1-4, the enclosure 10 is a power strip having a control portion 22 and a power distribution portion 24, seen in FIG. 2. The control portion 22 may include a switch 26, an indicator 28 and a circuit protection device 30, such as a fuse, secured to the cover 12 and a power cord 20 connected to one end wall 34, as shown. In this exemplary embodiment, the power distribution portion 24 has one or more devices 16, here duplex receptacles, each having a face that extends through openings (not shown) in the cover 12 to permit external connection to the receptacles. Electrical connections between devices 16, power cord 20, switch 26, indicator 28 and circuit protection device 30 are made as is known in the art.

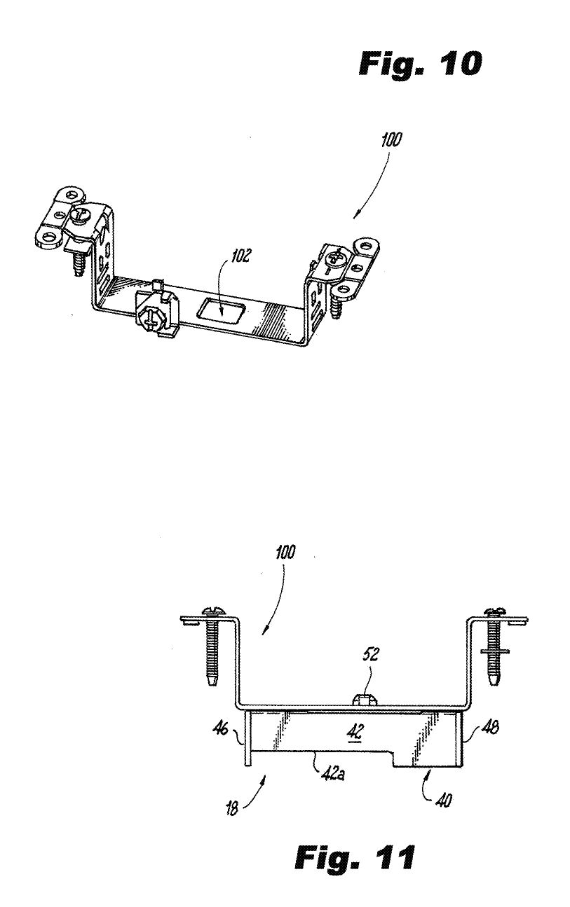

Positioned between a bottom surface 16a of each device 16 and the base 14 is one or more support members 18. In the embodiment shown in FIGS. 1-4, a single support member 18 is positioned between the bottom surface 16a of each device 16 and the base 14. A support member 18 according to an exemplary embodiment is shown in FIGS. 5-8. In this exemplary embodiment, the support member 18 has a hollow, rectangular body 40 having two side walls 42 and 44, two end walls 46 and 48, a top wall 50 defining an open interior portion. However, the body 40 may be a solid body or a partially hollow body. As seen in FIG. 8, the length “L” of the body 40 is preferably sufficient to extend along the length of the device 16 it is supporting. As seen in FIG. 8, the width “W” of the body 40 is preferably sufficient to permit the bottom surface 16a of the device 16 to rest on the top wall 50 of the body. As seen in FIG. 7, the height “H” of the body 40 is also preferably sufficient to permit the bottom surface 16a of the device 16 to rest on the top wall 50 of the body when installed in the enclosure 10. The side walls 42 and 44 of the body 40 each have one or more notches 42a and 44a, respectively, that allow the body to fit over potential obstacles in the base 14, such as detents, or to allow wires to pass under the support member 18. The top wall 50 of the body 40 may have an alignment post 52 extending away from the body 40. The alignment post 52 is preferably configured to fit within an opening 102 in a mounting yoke 100 of the device 16, as seen in FIGS. 10 and 11. The alignment post 52 is used to align the support member 18 with the device 16 and fix the positioning of the support member 18 relative to the device 16. The support member 18 can be made of a non-metallic material such as plastic, porcelain, and carbon fiber, or a metallic material such as steel or aluminium.

By positioning the support member 18 between the device 16 and the base 14, when a plug is inserted into the device 16, e.g., a receptacle, the force exerted on the receptacle by the insertion of the plug is absorbed across the support member 18 limiting movement of the receptacle and thus reducing the stress on the receptacle.

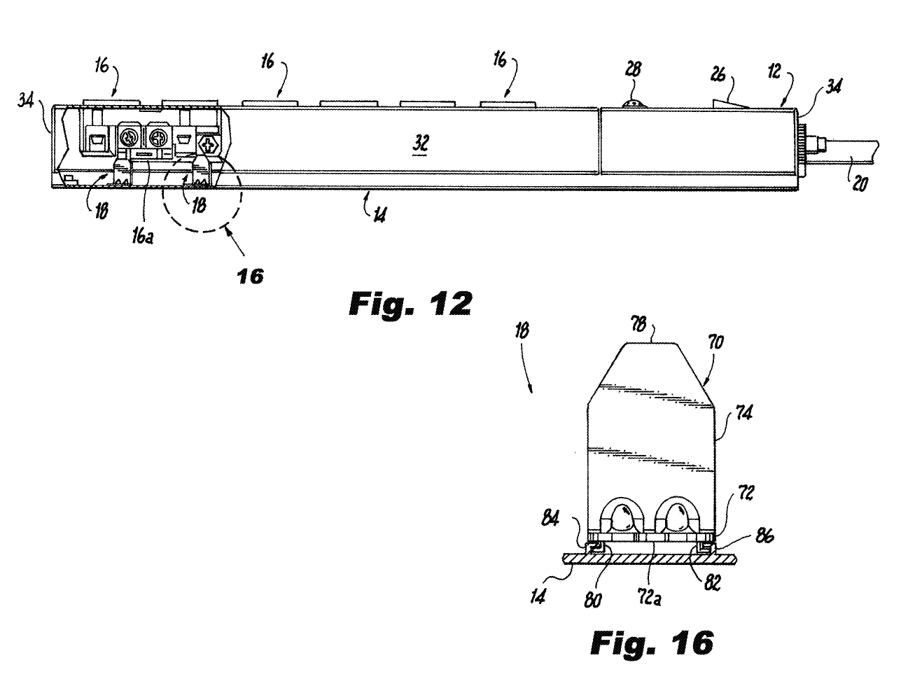

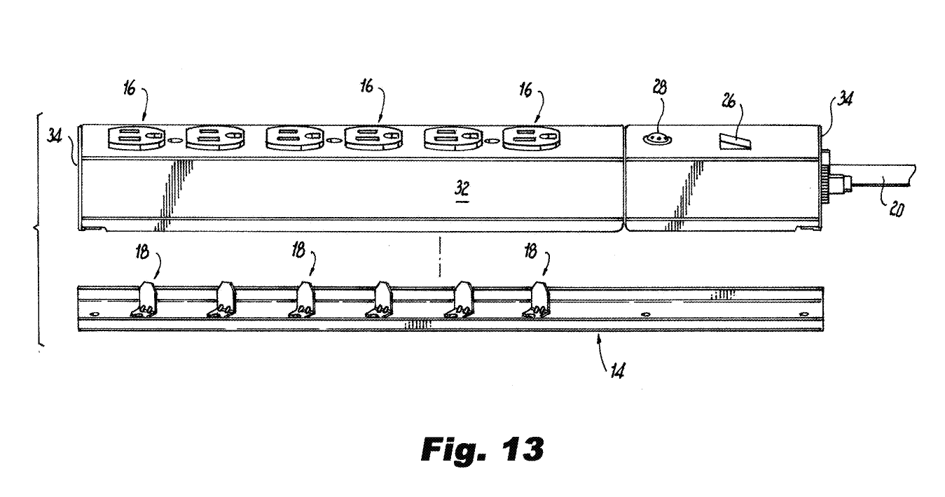

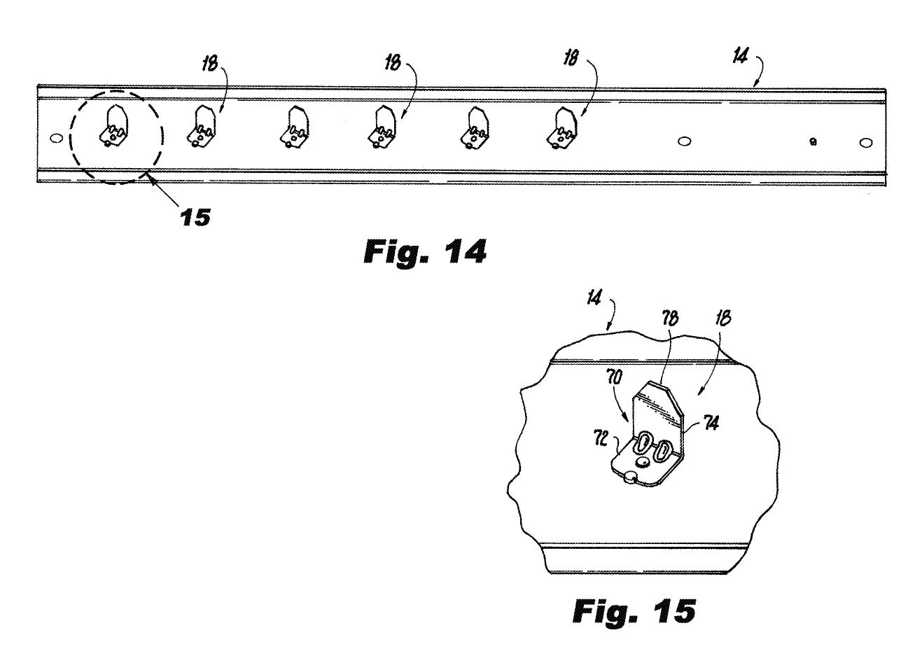

Turning to FIGS. 12-16, another exemplary embodiment of an enclosure according to the present disclosure is shown. In this exemplary embodiment, the enclosure 60 is similar to the enclosure 10 described above, such that similar components are assigned the same numbers. Thus, the enclosure 60 includes a cover 12, a base 14, one or more devices 16 and one or more support members 18. The difference in this exemplary embodiment is the support member 18. In FIGS. 14 and 15, detail 15 shows the support member 18 secured to the base 14.

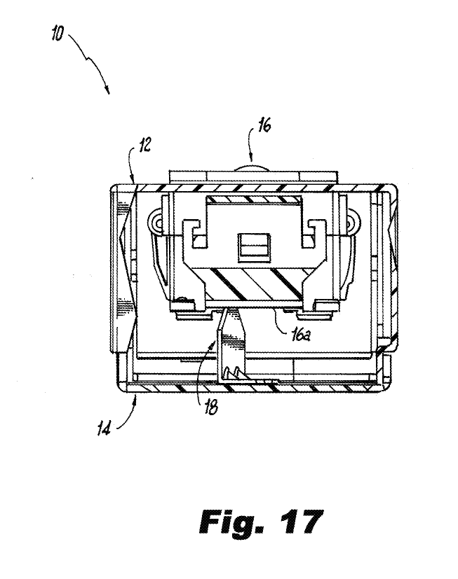

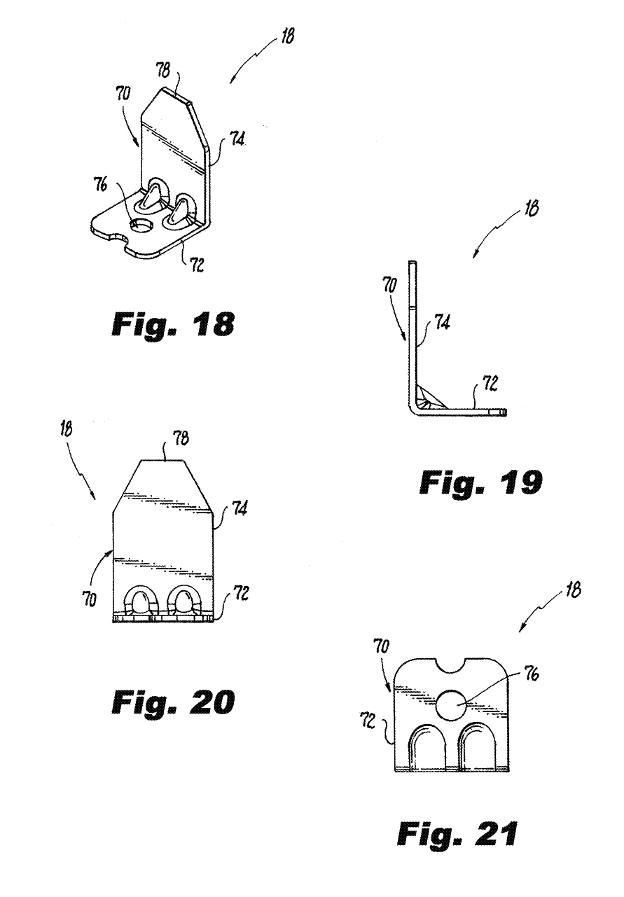

Positioned between a bottom surface 16a of each device 16 and the base 14 are two or more support members 18. In the embodiment shown in FIGS. 12-16, two support members 18 are positioned between the bottom surface 16a of each device 16 and the base 14. The support members 18 are spaced apart so that one support member 18 is positioned near one end of the device 16, and the other support member 18 is positioned near the other end the device 16. A support member 18 according to this exemplary embodiment is shown in FIGS. 17-20. The support member 18 has a body 70 that is configured to be secured to the base 14 of the enclosure 10 adjacent the device 16 and extend toward and contact the device 16. The body 70 in this exemplary embodiment has a base 72 and a vertical wall 74. The base 72 is configured and dimensioned to fit on the base 14 of the enclosure 10, and is releasably secured to the base 14 using, for example, rivets or other mechanical fasteners through an aperture 76 in the base 72. In another exemplary embodiment shown in FIG. 16, the bottom surface 72a of the base 72 has two rails 80 and 82 extending therefrom. The rails 80 and 82 are configured to mate with, e.g., slide into engagement with, rails 84 and 86 extending from the base 14. The vertical wall 74 can be secured to the base 72 or integrally formed into the base. The vertical wall 74 extends from the base 72 toward the device 16 and has a device contacting surface 78 that preferably contacts the device 16 when installed. In the exemplary embodiment shown, the base 72 and vertical wall 74 form an L-shaped body 70. However, the body 70 may have difference shapes and may come in different sizes. The device contacting surface 78 of the vertical wall 74 may be tapered, as shown, to reduce the surface area of the vertical wall 74 that contacts the device 16.

It will be understood that various modifications can be made to the embodiments of the present disclosure without departing from the spirit and scope thereof. Therefore, the above description should not be construed as limiting the disclosure, but merely as embodiments thereof. Those skilled in the art will envision other modifications within the scope and spirit of the invention as defined by the claims appended hereto.

What is claimed is:

1. An electrical enclosure comprising:
a base;
a cover that can be releasably secured to the base and having a pair of end walls, a pair of side walls and a top surface forming an open interior portion;
at least one electrical wiring device positioned within the open interior portion of the cover and secured to the cover, the at least one electrical wiring device being accessible through at least one opening in the top surface of the cover; and
at least one support member positioned between each of the at least one electrical wiring device and the base.

2. The electrical enclosure according to claim 1, wherein each at least one support member is configured to contact the at least one electrical wiring device and the base when positioned between the at least one electrical wiring device and the base, such that force exerted on the electrical wiring device is absorbed by the support member.

3. The electrical enclosure according to claim 1, wherein each at least one support member comprises a body having two side walls, two end walls and a top wall.

4. The electrical enclosure according to claim 3, wherein the top wall of the support member has an alignment post extending away from the body, wherein the alignment post is configured to align the support member with the electrical wiring device.

5. The electrical enclosure according to claim 3, wherein the two side walls have at least one notch.

6. The electrical enclosure according to claim 1, wherein each at least one support member comprises a base and a vertical wall extending from the base.

7. The electrical enclosure according to claim 1, wherein the vertical wall is integrally formed into the base.

8. The electrical enclosure according to claim 7, wherein the vertical wall is secure to the base.

9. The electrical enclosure according to claim 1, wherein the electrical wiring device comprises at least one of a single receptacle, a duplex receptacle, a USB charger, a circuit interrupting receptacle, a switch/receptacle combination, a toggle switch, a three-way switch, rocker switches, press switches, occupancy sensors, lighted indicators, resettable overcurrent devices, and motor controllers.

10. An electrical enclosure comprising:
a base having a pair of end walls, a pair of side walls and a bottom surface forming an open interior portion;
a cover that can be releasably secured to the base;
at least one electrical wiring device positioned within the open interior portion of the base and secured to the cover, the at least one electrical wiring device being accessible through at least one opening in the cover; and
at least one support member positioned between each of the at least one electrical wiring device and the bottom surface of the base.

11. The electrical enclosure according to claim 10, wherein each at least one support member is configured to contact the at least one electrical wiring device and the bottom surface of the base when positioned between the at least one electrical wiring device and the bottom surface of the base, such that force exerted on the electrical wiring device is absorbed by the support member.

12. The electrical enclosure according to claim 10, wherein each at least one support member comprises a body having two side walls, two end walls and a top wall.

13. The electrical enclosure according to claim 12, wherein the top wall of the support member has an alignment post extending away from the body, wherein the alignment post is configured to align the support member with the electrical wiring device.

14. The electrical enclosure according to claim 12, wherein the two side walls have at least one notch.

15. The electrical enclosure according to claim 10, wherein each of the at least one support member comprises a base and a vertical wall extending from the base.

16. The electrical enclosure according to claim 15, wherein the vertical wall is integrally formed into the base.

17. The electrical enclosure according to claim 15, wherein the vertical wall is secure to the base.

18. The electrical enclosure according to claim 10, wherein the electrical wiring device comprises one of a single receptacle, a duplex receptacle, a USB charger, a circuit interrupting receptacle, a switch/receptacle combination, a toggle switch, a three-way switch, rocker switches, press switches, occupancy sensors, lighted indicators, resettable overcurrent devices, and motor controllers.
